(19) United States
(12) Patent Application Publication
(10) Pub. No.: US 2012/0126653 A1
(43) Pub. Date: May 24, 2012

(54) AXIAL-FLUX THIN-PLATE MOTOR

(75) Inventors: Yee-Pien Yang, Taipei City (TW); Shih-Hsin Hsu, Taipei County (TW); Shih-Hsiang Chien, Yilan County (TW)

(73) Assignee: INDUSTRIAL TECHNOLOGY RESEARCH INSTITUTE, Hsin-Chu (TW)

(21) Appl. No.: 13/149,857

(22) Filed: May 31, 2011

(30) Foreign Application Priority Data
Nov. 23, 2010 (TW) 099140355

(51) Int. Cl. H02K 21/24; H02K 3/52; H02K 3/34

(52) U.S. Cl. 310/156.32; 310/215

(57) ABSTRACT

An axial-flux thin-plate motor is disclosed, which includes: a stator formed of an annular disk of silicon steel and comprising a plurality of teeth formed on one side of the annular disk, a plurality of insulation sleeves, each insulation sleeve having a shape which matches each tooth, and a plurality of coils, each coil formed around outside of each insulation sleeve, the coils connected and grouped to form n-phase windings in accordance with a phase number n of the motor; and a rotor formed of a ferromagnetic disk with a plurality of permanent magnets embedded on one side of the ferromagnetic disk.

### CROSS-REFERENCE TO RELATED APPLICATION

This non-provisional application claims priority under 35 U.S.C. §119(a) on Patent Application No. 099140355 filed in Taiwan R.O.C. on Nov. 23, 2010, the entire contents of which are hereby incorporated by reference.

### TECHNICAL FIELD

The present disclosure relates to an axial-flux thin-plate motor, and more particularly, to a stator structure of the axial-flux thin-plate motor to increase its slot fill ratio and lower its torque ripple.

### TECHNICAL BACKGROUND

Regarding conventional slim motors, the coils wound around the teeth of the motor stator are formed by a winding machine; therefore, a large slot opening is required for the winding and the slot fill ratio of the stator coils is less than 50%. To increase the slot fill ratio and lower the torque ripple, a motor stator disk can be formed by coiling a punched strip of silicon steel plate, disposing a stator coil of more than 70% slot fill ratio around the tooth on the stator disk, and then embedding shaped tooth shoes into the gap between the tooth and coil. The tooth shoes can be formed of a ferromagnetic material to guide the axial magnetic flux to pass through the air gap in accordance with the shape of the top surface of the tooth shoe. Thus, the torque ripple can be improved and the torque density can be increased to lead to a light slim motor of low cost.

However, the traditional manufacturing process of axial-flux motors did not lead to a high slot fill ratio, so that the thickness and weight of stator disk were not reduced. Furthermore, the slot opening must be large enough for the windings to be inserted into the stator slot by a traditional manufacturing process. This was an additional disadvantage for the motor to have large torque ripples.

### TECHNICAL SUMMARY

According to one aspect of the present disclosure, one embodiment provides an axial-flux thin-plate motor comprising: a stator formed of an annular disk of silicon steel and comprising a plurality of teeth, a plurality of insulation sleeves, and a plurality of coils; and a rotor formed of a ferromagnetic disk with a plurality of permanent magnets embedded on one side of the ferromagnetic disk; wherein the teeth formed on one side of the annular disk; each insulation sleeve having a shape to match each tooth; and each coil formed around outside of each insulation sleeve, the coils connected and grouped to form n-phase windings in accordance with a phase number n of the motor.

The features of the axial-flux thin-plate motor can be summarized as follows. First, the annular disk-like stator is formed of a strip of silicon steel plate. The silicon steel strip is punched to form a lot of recesses along the strip, and then is tightly wound to become an annular disk. The pitch between any two adjacent recesses on the silicon steel strip must be adjusted to form stator teeth and slots with smoothly continuous tooth sides. The annular disk is then made to form a basic structure of the stator disk, with the teeth without tooth shoes thereon. The prior-art stators are formed of laminated silicon steel plates; however, the stator disk in the embodiments is fabricated by other means. A silicon steel plate is striped, punched with recesses of gradually increased pitch along the strip, and wound tightly into an annular disk. The fabrication process for the strip and the disk of silicon steel can thus be integrated, with lower cost and higher production efficiency. Second, each coil is tightly wound around outside of an insulation sleeve, and the insulation sleeves with coils are disposed on the stator teeth. Then the coils are connected and grouped into phases of the motor. Thus, the slot fill ratio of the stator coils can be upgraded to more than 70%. The coils in the embodiments are not directly wound around the stator disk, but are respectively wound around outside of insulation sleeves. The coiled insulation sleeves are then disposed on the teeth of the stator disk. Hence, it is not necessary to use complex winding machine to make windings as in the prior arts but only basic and low-cost winding machines are needed. Third, the tooth shoe can be fabricated by different ferromagnetic materials, such as soft magnetic composite, low-carbon steel, and the like. The top of tooth shoe can be made a curved surface, in order to modify the distribution of air-gap length and guide the axial magnetic flux to pass through the air gap in accordance with the shape of the top surface of tooth shoe. Thus, the torque ripple can be lowered. The shaped tooth shoe can be embedded into the stator disk to form a disk-like stator of high slot fill ratio. The shape of the top of tooth shoe can be modified in its cross-section and curved surface, to modify the distribution of air-gap length and to reduce the slot opening, so as to minimize the torque ripple and improve the motor performance.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a perspective view of a disk-like stator according to an embodiment of the present disclosure.

FIGS. 2A and 2B are, respectively, a side view and a top view of a disk-like rotor according to an embodiment of the present disclosure.

FIG. 3 is a structure of a punched strip of silicon steel plate to form the annular stator disk.

FIG. 4A is the structure of the disk-like stator with the teeth of various slot pitches along the radius.

FIG. 4B is the structure of the disk-like stator with grooves on the side walls of teeth.

FIGS. 5A to 5E are the assembly structure of the stator disk according to a first embodiment of the present disclosure; FIGS. 5A to 5C are, respectively, perspective views of tooth, insulation sleeve with coils, and the tooth shoe, and FIGS. 5D and 5E are, respectively, a perspective and a cross-sectional views of the assembly structure.

FIGS. 6A to 6C are the assembly structure with a fastening part (FIG. 6C) of tooth (FIG. 6A) and an insulation sleeve on the tooth (FIG. 6B) according to a second embodiment of the present disclosure.

FIGS. 7A and 7B are, respectively, an exploded perspective and a perspective views for the assembly structure of the tooth and insulation sleeve according to a third embodiment of the present disclosure.

FIGS. 8A and 8B are respectively an exploded perspective and a perspective views for the assembly structure of the stator disk according to a fourth embodiment of the present disclosure.

FIG. 9 is a perspective view of the stator according to an embodiment of the present disclosure.

### DESCRIPTION OF THE EXEMPLARY EMBODIMENTS

For further understanding and recognizing the fulfilled functions and structural characteristics of the disclosure, several exemplary embodiments cooperating with detailed description are presented as the following.

In the present disclosure, an axial-flux motor of thin-plate structure is provided. The axial-flux motor is mainly composed of a disk-like stator and a disk-like rotor and used, for example, in a flat or narrow space vertical to the wheel shaft to convert electrical energy into mechanical energy or wheel rotation. The operational principle of the axial-flux motor is briefly described below. An electromagnet is generated when electric current passes around the coils surrounding the stator teeth. The electromagnet interacts with the magnetic field produced by the magnets on the disk-like rotor, whereby the wheel shaft that connects the rotor rotates. However, this disclosure is not limited to the application of vehicle, but also can be utilized in the fields where a slim or disk-shaped motor is in need. An annular air gap is formed between the disk-like stator and the disk-like rotor. A magnetic flux loop is formed from the rotor magnet via the air gap to the stator, then through the back iron of the stator and back to the air gap, then along the rotor axis back to the rotor and its back iron. The magnetic energy in the air gap is dependent on the relative position between the stator and the rotor, so as to generate a torque in the direction of rotor axis.

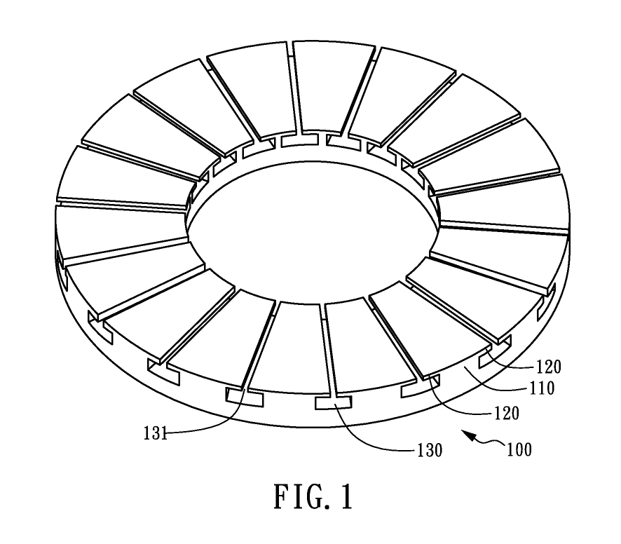

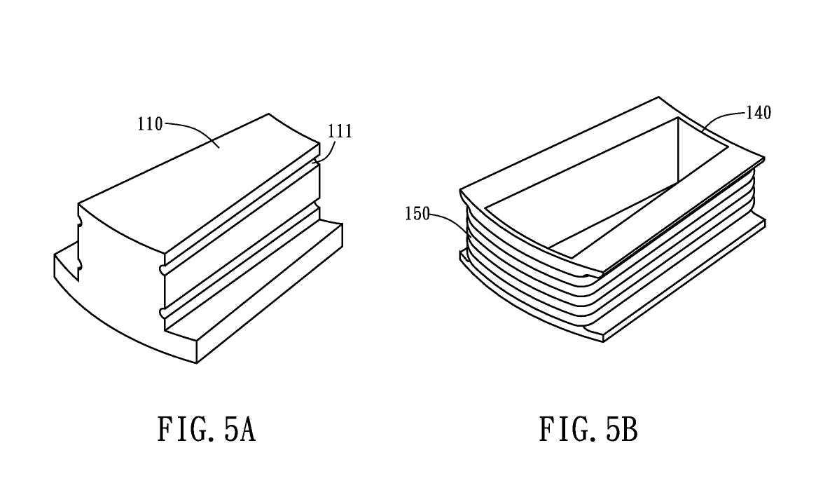

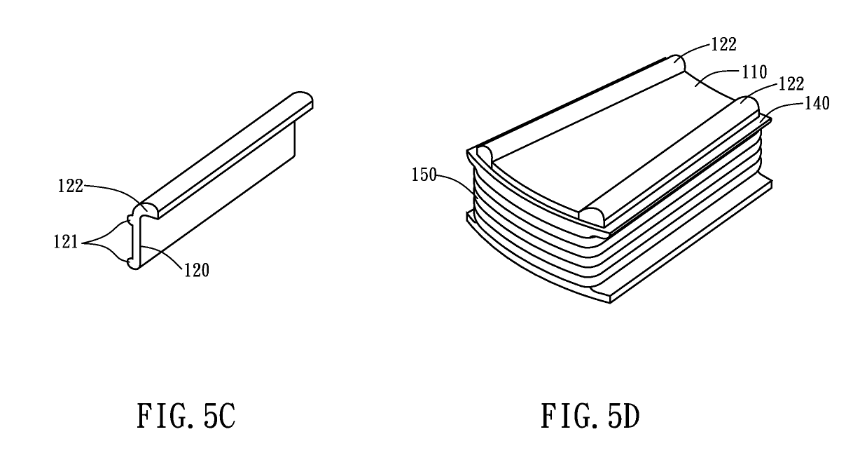

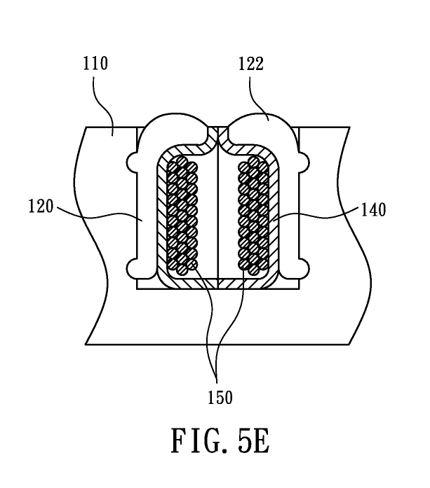

Please refer to FIGS. 1 and 5A to 5E. FIG. 1 is a perspective view of a disk-like stator according to an embodiment of the present disclosure. In FIG. 1, the disk-like stator 100, formed of an annular disk of silicon steel, comprises: a plurality of teeth 110 and a plurality of tooth shoes 120. For the sake of clarity, a single tooth 110 is redrawn in FIG. 5A. To increase the slot fill ratio and to decrease the torque ripple of an axial-flux thin-plate motor, the disk-like stator 100 further comprises a plurality of insulation sleeves 140 and a plurality of coils 150, as shown in FIG. 5B. The teeth 110 are formed on one side of the annular disk. Each insulation sleeve 140 has a shape which matches and coats each tooth 110 thereof. Each coil 150 is tightly wound around outside of each insulation sleeve 140. These insulation sleeves 140 with coils 150 are inserted into tooth slots 130, so as to form a stator winding structure of high slot fill ratio. The coils 150 are connected and grouped in series or in parallel to form n-phase windings in accordance with the phase number n of the motor. FIG. 5C schematically shows the structure of the tooth shoe 120, and each tooth shoe 120 embedded into each tooth 110. FIG. 5D shows the assembled architecture of the tooth 110, insulation sleeve 140, and tooth shoe 120.

In the foregoing embodiment, each tooth shoe 120 is formed and then combined with the tooth 110 and the insulation sleeve 140, as shown in FIG. 5E. On the other hand, the tooth shoe 120 can be integrally shaped with the tooth 110 and, thus, extended from the top of the tooth 110, as shown in FIG. 1, where the disk-like stator 100 is based on the annular disk. The teeth 110 are punched and molded with the tooth slots 130 between any two adjacent teeth 110. Moreover, the top of tooth shoe 120 can be made a planar surface, as shown in FIG. 1, or a curved surface 122 with a projection, as shown in FIGS. 5C and 5D. In an exemplary embodiment, the tooth shoes 120 are integrally formed of ferromagnetic material or soft magnetic composite with the teeth 110. The tooth shoe 120 can be properly design to form a vertical or curved slot opening 131, so that the resultant distribution of magnetic flux in the air gap can become as smooth as a sinusoidal wave, leading to a small torque ripple and thus a smooth motor operation.

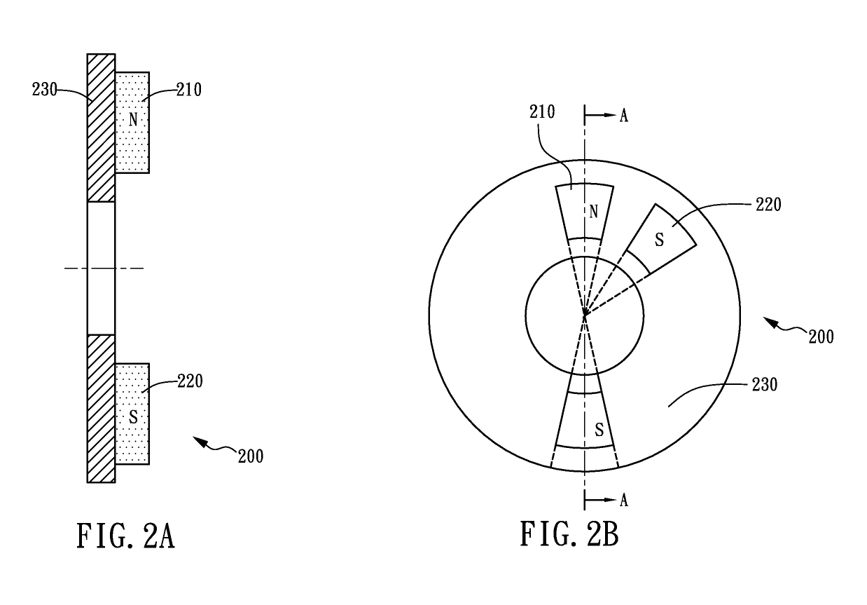

FIGS. 2A and 2B are, respectively, a side view and a top view of a disk-like rotor according to an embodiment of the present disclosure. Referring to FIGS. 2A and 2B, the disk-like rotor 200 comprises: a ferromagnetic disk 230 and a plurality of permanent magnets 210 and 220 embedded on one side of the ferromagnetic disk 230. The permanent magnets 210 and 220 can be in a shape of fan, circle, rectangle, and the like, or the other shapes. The permanent magnets include at least one pair of N-pole 210 and S-pole 220 magnets, where the location of each N-pole magnet 210 is symmetrical to each S-pole magnet 220 with a symmetry point at the center of the rotor disk 230. The rotor disk 230 is made of ferromagnetic material to facilitate the magnet flux from the stator 100 through the air gap to the rotor 200 in closed loops.

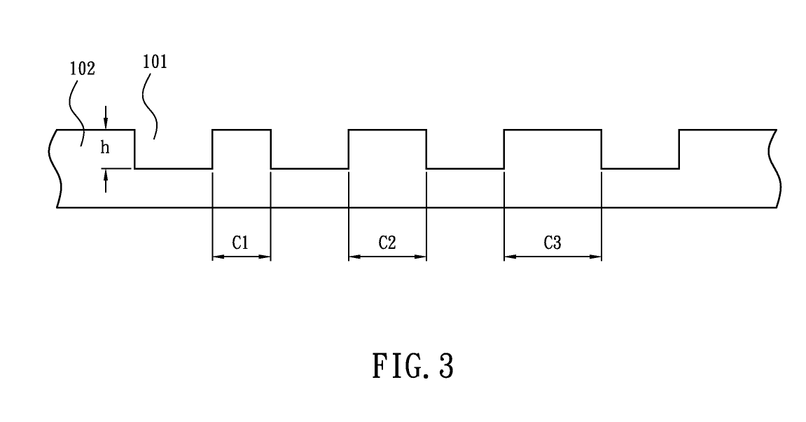

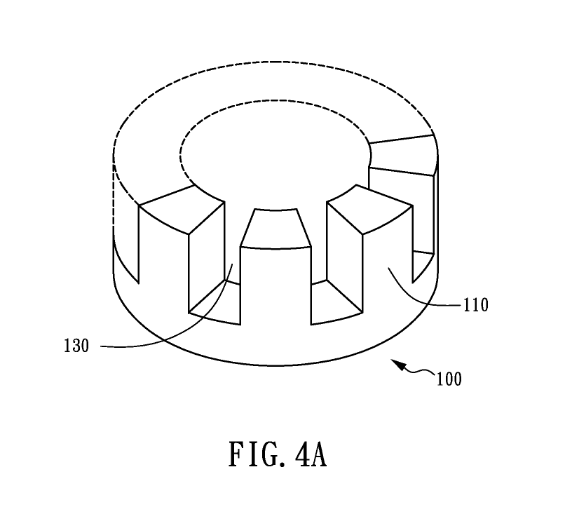

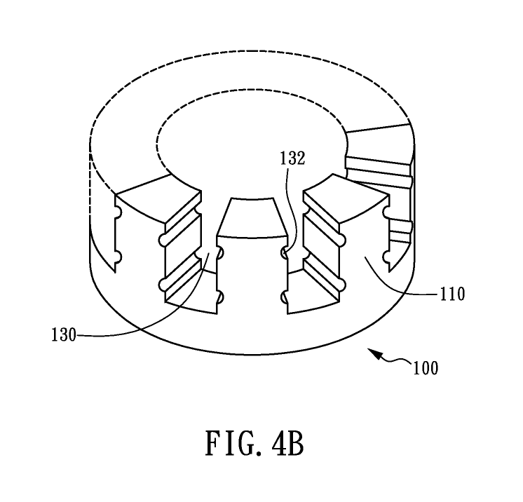

The annular disk of the disk-like stator 100 is formed of a strip of silicon steel plate. The silicon steel strip is punched to form a lot of recesses 101 along the strip, with an interposed height 102 between any two adjacent recesses 101, as shown in FIG. 3. The pitch of the recesses may be adjusted to form stator teeth and slots with smoothly continuous tooth sides. The pitch may increase gradually along the stripe so that a larger pitch is adjusted for the strip winging with larger radius of the stator disk. For example, C1<C2<C3 as shown in FIG. 3. The annular disk is then shaped to form the teeth 110 with the tooth slots 130 between any two adjacent teeth 110. Please refer to FIG. 4A, which schematically illustrates the structure of the disk-like stator 100 with the teeth 110 of various slot pitches along the radius. Here the slot pitch is designated as an arc length of the disk's circumference occupied by a tooth. Further, one or more grooves 132 can be formed on the side walls of the teeth 110, as shown in FIG. 4B. In this case, one or more protrusions 121 are formed on the tooth shoe, and each groove corresponds to each protrusion so as to fix the tooth shoe onto the tooth. The cross-section of the tooth slot 130 may be formed in a parallelogram, and the top of the tooth 110 may be formed in a fan-like cross-section.

To increase the density of coils wound around the tooth 110, the tooth insulation sleeve 140 is disposed between the tooth 110 and the coil 150. By using the insulation sleeves 140, a slot fill ratio of more than 70% can be obtained, so as to satisfy the potential fabrication requirements of more criticalness for the axial-flux thin-plate motor.

Regarding the insulation sleeve 140, several exemplary embodiments are described below. Please refer to FIGS. 5A to 5E. FIG. 5E shows the assembly structure of the tooth 110, tooth shoe 120, and insulation sleeve 140 according to a first embodiment of the present disclosure. The insulation sleeve 140, made of plastic material, is tightly wound with the coils 150. Then the insulation sleeve 140 is disposed onto tooth 110 with a gap between the tooth 110 and the insulation sleeve 140. The gap serves as a receiving space for the tooth shoe 120 to be embedded into. The tooth shoe 120 is made in a curved shape, so that when the tooth shoe 120 is inserted into the gap, the insulation sleeve 140 is deformed slightly to fit and clip the tooth shoe 120. In this embodiment, two protrusions 121 are formed on the tooth shoe while two grooves 132 are formed on the side wall of the tooth 110 (also as shown in FIG. 4B). The grooves 132 and the protrusions 121 fit and correspond to each other so as to fix the tooth shoe 120 onto the tooth 110 intimately, as shown in FIG. 5E.

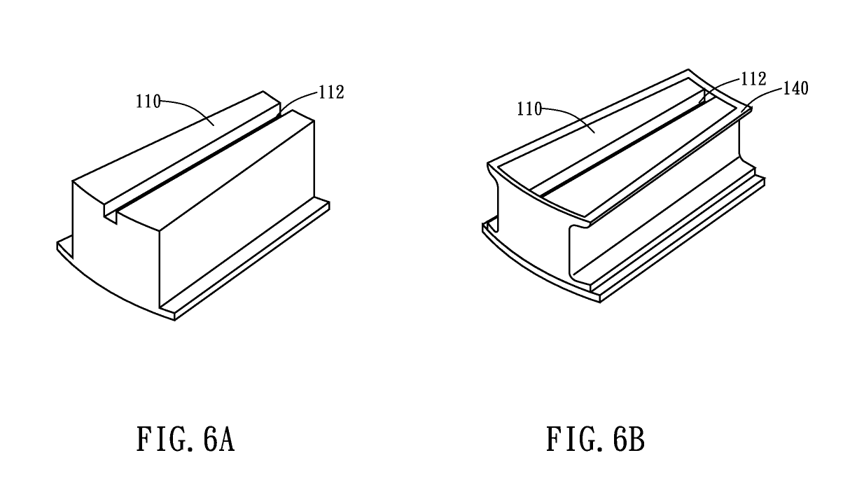

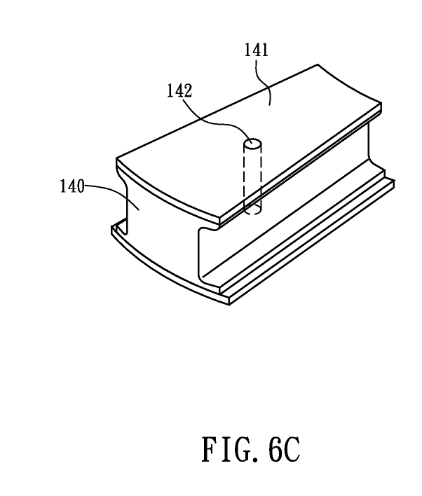

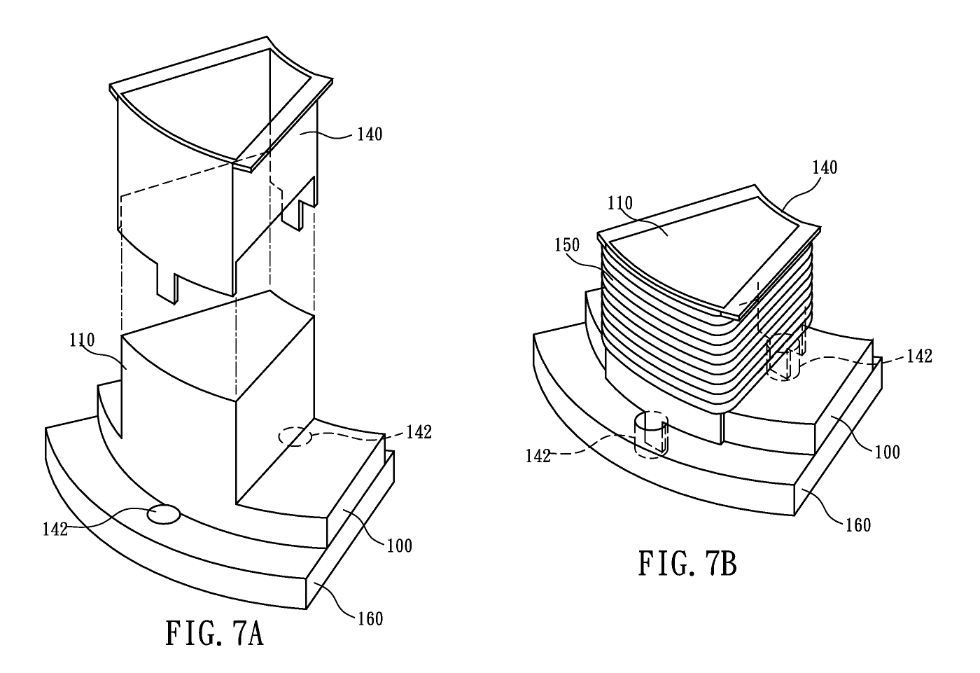

Referring to FIGS. 6A to 6C, FIG. 6C shows the assembly structure with a fastening part of tooth 110 and an insulation sleeve 140 on the tooth according to a second embodiment of the present disclosure. The second embodiment is similar to the first one except that a tooth hat 141 is disposed to replace the tooth shoe 120 and to fix the insulation sleeve 140 to the tooth 110. The insulation sleeve 140 is disposed around the tooth 110, and a ditch 112 is formed on top of the tooth 110. A tooth hat 141 having a strip-shaped projection under its bottom (not shown in FIG. 6C) and corresponding to the ditch 112 is disposed on top of the tooth 110 in a manner that the projection is embedded into the ditch 112. Then a screw or a rivet is used as a fixer 142 to fix the tooth hat 141 onto the tooth 110. Since the extension of tooth hat 141 exceeds the top of tooth 110 in width, the insulation sleeve 140 can be fixed to the tooth 110 without participation of the tooth shoe 120.

Referring to FIGS. 7A and 7B, FIG. 7B shows the assembly structure of the tooth 110 and insulation sleeve 140 according to a third embodiment of the present disclosure. In FIGS. 7A and 7B, the stator disk 100 further comprises a stator base 160 joined to the bottom of the stator disk 100. It is noted that the insulation sleeve 140 can be composed of ferromagnetic steel in this embodiment. In this example, the insulation sleeve 140 is made of stainless steel. The edge or extension of the insulation sleeve 140 is designed to exceed the top of the tooth 110 in width, and a fixer 142 such as a rivet or a solder is used to bond the insulation sleeve 140 to the stator base 160, so that the insulation sleeve 140 can be fixed to the tooth 110 without participation of the tooth shoe 120.

Wires are tightly wound around outside of each insulation sleeve 140 to form a coil 150. Then the insulation sleeve 140 with coil is disposed to surround the tooth 110, as shown in FIG. 5B, 6B, or 7B. Coils 150 are then connected and grouped in series or in parallel to form n-phase windings in accordance with a phase number n of the motor.

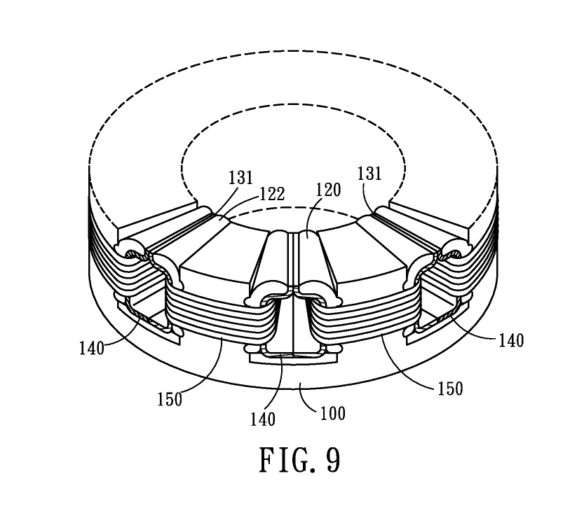

The tooth shoe 120 can be made of ferromagnetic material, as shown in FIG. 5C. The shape of tooth shoe 120 is designed to let the interval between the adjacent teeth 110 be larger than the minimum air gap. Referring to FIG. 9, which shows a perspective view of the stator according to an embodiment of the present disclosure, the top of tooth shoe 120 may be made of a curved surface 122 to lower the torque ripple by modification of the magnetic reluctance in the air gap. The tooth shoe 120 can be made of soft magnetic composite, and the tooth shoe 120 is properly design to form a vertical (as shown in FIG. 1) or curved slot opening 131, so that the magnetic flux in the axial direction can be formed in a sinusoid-like distribution, leading to a smaller torque ripple. The insulation sleeve 140 can be disposed between the tooth 110 and the tooth shoe 120 to receive the coil 150. After the coil 150 is wound around the insulation sleeve 140, the stator disk 100 can then be assembled. The as-described structure of the stator disk 100 can have a high slot fill ratio of coil, which leads to teeth of less height and thus a lighter motor.

The stator disk 100 can be assembled inside an outer case of the motor, filled between which is thermal conductive gel. Heat-radiating fins are formed on the outer surface of motor housing, whereby the heat produced in motor can be transferred to the outer case and then cooled by external air flow.

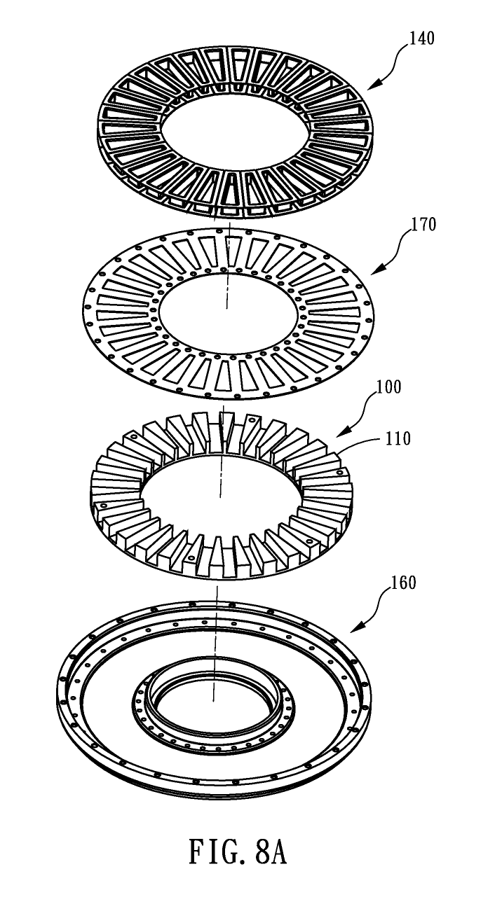

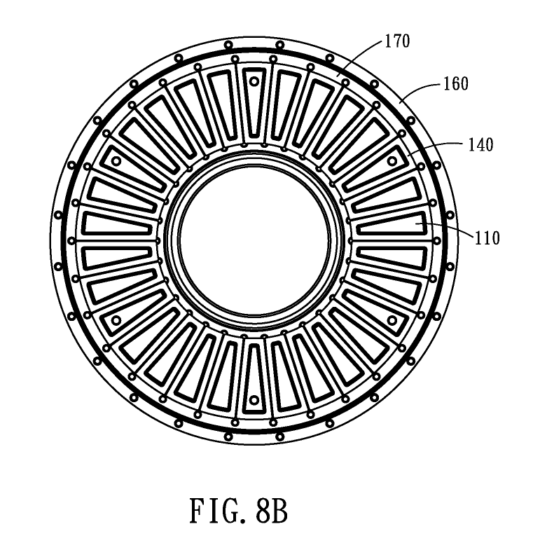

FIGS. 8A and 8B show, respectively, an exploded perspective and a perspective views for the assembly structure of the stator disk 100 according to a fourth embodiment of the present disclosure. Referring to FIGS. 8A and 8B, a stator base 160 is joined to the bottom of the stator disk 100 on which the teeth 110 are shaped. The stator base 160 may be a part of the outer case. The stator base 160 may have a recess on its top to fit the bottom of the stator disk 100. The stator disk 100 may further comprise a clamp disk 170 with holes corresponding to the teeth 110, so that the clamp disk 170 can be fit to the stator disk 100 and disposed on the bottom of the tooth slots 130. Also, the clamp disk 170 can be bonded to the stator base 160 by means of soldering, riveting, or screwing. The insulation sleeve 140 is then disposed on the clamp disk 170 to assemble the stator disk 100.

From the foregoing description, the features of the axial-flux thin-plate motor according to this disclosure can be summarized as follows. First, the annular disk-like stator is formed of a strip of silicon steel plate. The silicon steel strip is punched to form a lot of recesses along the strip, and then is tightly wound to become an annular disk. The pitch between any two adjacent recesses on the silicon steel strip must be adjusted to form stator teeth and slots with smoothly continuous tooth sides. The annular disk is then made to form a basic structure of stator disk, with the teeth without tooth shoes thereon. It is noted that the prior-art stators are formed of laminated silicon steel plates; however, the stator disk in the embodiment is fabricated by other means. A silicon steel plate is striped, punched with recesses of gradually increased pitch along the strip, and wound tightly into an annular disk. The fabrication process for the strip and the disk of silicon steel can thus be integrated, with lower cost and higher production efficiency.

Second, each coil is tightly wound around outside of an insulation sleeve, and the insulation sleeves with coils are disposed on stator teeth. Then the coils are connected and grouped into phases of the motor. Thus, the slot fill ratio of the stator coils can be upgraded to more than 70%. The coils in the embodiments are not directly wound around the stator disk, but are respectively wound around outside of insulation sleeves. The coiled insulation sleeves are then disposed on the teeth of the stator disk. Hence, it is not necessary to use complex winding machine to make windings as in the prior arts but only basic and low-cost winding machines are needed.

Third, the tooth shoe can be fabricated by different ferromagnetic materials, such as soft magnetic composite, low-carbon steel, and the like. The top of tooth shoe can be made a curved surface, in order to modify the distribution of air-gap length and guide the axial magnetic flux to pass through the air gap in accordance with the shape of the top surface of tooth shoe. Thus, the torque ripple can be lowered. The shaped tooth shoe can be embedded into the stator disk to form a disk-like stator of high slot fill ratio. The shape of the top of tooth shoe can be modified with curved surface, to modify the distribution of air-gap length and to reduce the slot opening, so as to minimize the torque ripple and improve the motor performance.

With respect to the above description then, it is realized that the optimal relationship in dimensions or improvement in manufacturing process for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. An axial-flux thin-plate motor comprising:
a stator formed of an annular disk of silicon steel and comprising
a plurality of teeth formed on one side of the annular disk;
a plurality of insulation sleeves, each insulation sleeve having a shape which matches each tooth; and
a plurality of coils, each coil formed around outside of each insulation sleeve, the coils connected and grouped to form n-phase windings in accordance with a phase number n of the motor; and
a rotor formed of a ferromagnetic disk with a plurality of permanent magnets embedded on one side of the ferromagnetic disk.

2. The axial-flux thin-plate motor of claim 1, wherein the stator further comprises a plurality of tooth shoes, each tooth shoe embedded into each of the teeth.

3. The axial-flux thin-plate motor of claim 2, wherein the tooth shoes are formed of ferromagnetic material.

4. The axial-flux thin-plate motor of claim 3, wherein the tooth shoes are shaped of soft magnetic composite and low carbon steel.

5. The axial-flux thin-plate motor of claim 2, wherein each of the tooth shoes has a planar top.

6. The axial-flux thin-plate motor of claim 2, wherein each of the tooth shoes has a curved top.

7. The axial-flux thin-plate motor of claim 2, wherein a tooth slot formed between any two adjacent teeth has a vertical or curved opening.

8. The axial-flux thin-plate motor of claim 2, wherein a groove is formed on the side wall of the tooth, a protrusion is formed on the tooth shoe, and the groove and the protrusion correspond to each other so as to fix the tooth shoe onto the tooth.

9. The axial-flux thin-plate motor of claim 2, wherein the tooth shoes have various slot pitches along the radius.

10. The axial-flux thin-plate motor of claim 1, wherein the insulation sleeves are formed of plastic material or ferromagnetic steel.

11. The axial-flux thin-plate motor of claim 10, wherein the insulation sleeves are formed of stainless steel.

12. The axial-flux thin-plate motor of claim 1, wherein the stator further comprises a stator base, the stator base joined to the other side of the annular disk.

13. The axial-flux thin-plate motor of claim 1, wherein the stator further comprises a plurality of tooth hats, each tooth hat disposed on each top of the teeth to fix the insulation sleeve.

14. The axial-flux thin-plate motor of claim 1, wherein the stator further comprises a clamp disk having holes corresponding to the teeth, wherein the clamp disk is disposed on the annular disk to fix the insulation sleeve.
